(19) United States
(12) Patent Application Publication
(10) Pub. No.: US 2014/0195208 A1
(43) Pub. Date: Jul. 10, 2014

(54) EFFICIENT PARTITION REFINEMENT BASED REACHABILITY CHECKING FOR SIMULINKS/STATEFLOW MODELS

(71) Applicant: GM GLOBAL TECHNOLOGY OPERATIONS LLC, Detroit, MI (US)

(72) Inventors: Srihari Sukumaran, Bangalore (IN); Manoranjan Satpathy, Bangalore (IN)

(73) Assignee: GM GLOBAL TECHNOLOGY OPERATIONS LLC, Detroit, MI (US)

(21) Appl. No.: 13/737,227

(22) Filed: Jan. 9, 2013

(51) Int. Cl. G06F 17/50

(52) U.S. Cl. CPC G06F 17/5009
USPC 703/2

(57) ABSTRACT

A method for verifying reachability of a transition between states in a transition system using simulation modeling. Generating a concrete simulation model. Generating an abstract model having an abstract path that is a sequence of transition steps between a source state and a target state. Validity of the abstract path is checked. Identifying whether the abstract path is invalid in the concrete model. If invalid, then discarding the abstract path and generating a new abstract path. Re-checking a validity of each new abstract path. If abstract path is valid, then determining whether the abstract path is reachable from an initial condition. If reachable, then outputting the reachable transition to the user; otherwise, partitioning the source state into two additional state abstractions. Recomputing a refined abstract model retaining all transition paths except transitions that are determinative as invalid. Rechecking validity of an abstract path associated with the refined abstract model.

### BACKGROUND OF INVENTION

An embodiment relates generally to verification of input and output response signals in vehicle systems.

In automobiles, numerous functional systems are handled by electronic and control software applications. Such systems utilize distributed real-time embedded software systems that require high integrity development and verification processes.

Vehicle software systems are typically created as an initial abstract model of a controller which is then validated using physical testing or formal verification and are refined iteratively. Test sequences created to test each of the software applications by their input and output responses are applied to a device, subsystem, or system utilizing an actual vehicle or test bed. Physical testing requires setup of the test bed or physical components in an actual vehicle using actual hardware required for testing or validation. Simulation provides an alternative to actual hardware and test setup, however, verification of vehicle system test models for implementation in vehicle systems is subject to the issue of state-space scalability. That is, in testing a model using simulation, scalability of testing (i.e., expansion of testing data to cover all need test cases) may increase exponentially thereby creating a very time consuming and costly process.

### SUMMARY OF INVENTION

An embodiment contemplates a method for verifying reachability of a transition between states with respect to design and simulation modeling. A concrete simulation model is generated as a transition system. An abstract model is generated having an abstract path that is a sequence of transition steps between a source state and a target state. The source state is an inverse of the target state. A validity of the abstract path is checked utilizing the concrete simulation model. A result is output to a user that identifies whether the abstract path is invalid in the concrete model. If invalid then discarding the abstract path. A new abstract path is generated. Re-checking a validity of each new abstract path. If the abstract path is valid in the concrete model, then determining whether the abstract path is reachable from an initial condition. If reachable from the initial condition, then outputting the result to the user identifying the reachable transition between the source state and the target state; otherwise, partitioning the source state into two additional state abstractions. Recomputing a refined abstract model retaining all transition paths except transitions that are determinative as invalid. The refined abstract model includes a sequence of non-discarded transition steps. Rechecking validity of an abstract path associated with the refined abstract model using the concrete model.

### BRIEF DESCRIPTION OF DRAWINGS

FIG. 1 is an exemplary state diagram illustrating a transition in predicate form

FIG. 2 is an exemplary state diagram of a transition system

FIG. 3a is an exemplary state diagram of an initial abstraction.

FIG. 3b is an exemplary refined state diagram of the initial abstraction

FIG. 4a is an initial abstraction path for a model fsa(α⁰) as Ã₀.

FIG. 4b is a refinement of the initial abstract path in FIG. 4a.

FIG. 5a is a two-state abstraction of the transition system in FIG. 2.

FIG. 5b is an abstract model obtained by refinement of FIG. 5a.

FIG. 5c is a second refinement of the abstract model of FIG. 5a.

FIG. 6a illustrates a recompute of a situation before refinement utilizing a reachability technique shown in Algorithm 6.

FIG. 6b illustrates a recompute of the situation after refinement utilizing the reachibility technique shown in Algorithm 6.

FIG. 7a illustrates a two-state abstraction according to an alternative refinement strategy shown in Algorithm 7.

FIG. 7b illustrates a first refinement of the situation in FIG. 7a.

FIG. 7c illustrates a second refinement of the situation in FIG. 7a.

FIG. 7d illustrates a third refinement of the situation in FIG. 7a.

FIG. 8 illustrates an enhance reachability approach.

FIG. 9 illustrates a concrete model of a vehicle subsystem.

FIG. 10 illustrates an abstract model for a transition in the vehicle system.

FIG. 11 illustrates a pruned transition in the abstract model.

FIG. 12 illustrates a newly generated abstract path.

FIG. 13 illustrates a state space partitioned into two state spaces.

FIG. 14 illustrates additional iterations performed for the state space/transition.

FIG. 15 illustrates a generated test sequence valid in the concrete model.

### DETAILED DESCRIPTION

The invention includes a method of verification of a reachability of transition system models. The embodiments described herein utilize a counter-example guided abstraction refinement (CEGAR) based method for checking reachability properties of Simulink models. Simulink models are considered having underlying transition system semantics. The technique described herein is based on finite state abstractions built from partitions of state space of the transition system and the refinements of such abstractions by splitting of partitions based on an infeasible transition. The system for executing the technique as described herein utilizes at least one processor, a memory, and an output display device for outputting results to a user, a human machine interface for allowing a user to input control commands, and test device such as a test harness for checking the validity of modeled results on a hardware device. The processor may perform the following functions that include, but are not limited to, path generation, translation between a SL/SF model and a concrete model, validity checking, and model refinement.

The embodiments describe herein utilize concrete and abstract models. A transition system, represented as M, is a set of elements that include (1) a set of variables V, (2) an initial condition I, and (3) a transition relation (T).

The set of variables V include a set of input variables V_{?} and a set of output variables V_{!}; both these subsets have no element in common. Each variable υ∈V takes values from a domain D_{υ}. For a set of variables Z⊂V, the set of valuations of the variables in Z will be denoted by D(Z)Δx_{υ∈z}D_{υ}. The state space of M is thus ΓΔD(V).

The initial condition I is a predicate on the output variables in V. That is, I is a map:I:D(V_{!})→BOOLEAN. A valuation of variables in V_{!} is assigned the value of true provided the valuation satisfies the predicate denoting the initial state. I can also be denoted as the set of states (⊂Γ) satisfying the initial condition. Both these usages are mutually compatible.

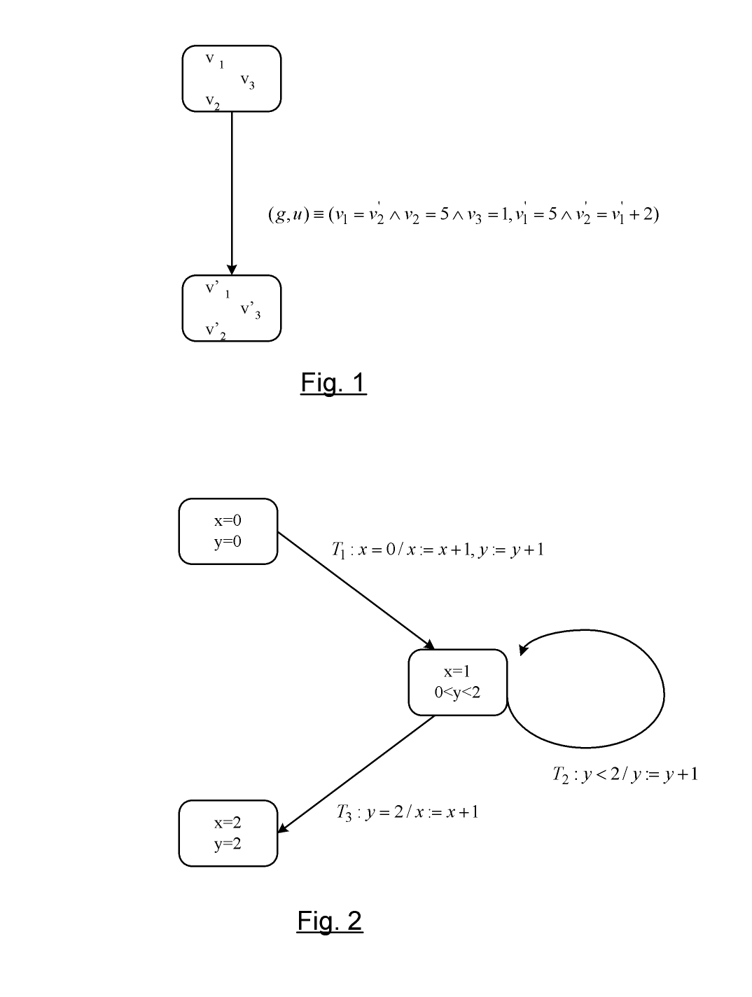

The transition relation T is a predicate on V and V′ where V′={υ′|υ∈V}. That is T is a map; T:D(V)×D(V)→BOOLEAN. Intuitively, for a variable υ, υ and υ′ denote the pre-transition and post-transition values of that variable. Analogous to the case with I, a set interpretation can be T⊂Γ×Γ. Valuations of the variable V are referred to as “states” in the transition system (i.e., s∈Γ). This includes input variables as well as output variables. This transition relation is expressed as a disjunctive combination of guard-action pairs {(gᵢ,aᵢ)}. In general, a guard gᵢ, can be a predicate on V and V′ (i.e., gᵢ⊂Γ×Γ). An action aᵢ is a set of equation of the form ν′=e(V,V′)², where ν∈V_{!} and each variable in V_{!} occurs exactly once on LHS, and e(V,V′) is an expression on V and V′ that evaluates to a value in domain D_{ν}. Such an action aᵢ can be translated to an equivalent predicate uᵢ on V and V′, i.e., uᵢ⊂Γ×Γ. Refer to FIG. 1 which shows a transition in predicate form. The transition in predicate is represented by

(g,u)≡(ν₁=ν′₂ [symbol] ν₂=5 [symbol] ν₃=1, ν′₁=5 [symbol] ν′₂=ν′₁+2)

where V_{!}={ν₁,ν₂} and V_{?}={ν₃}.

Valuations of the variables V are called the states of the transition system, s∈Γ. Note that this includes input as well as output/internal variables. The notation s|z will refer to the projection of the state onto the set Z⊂V (i.e., it denotes the notation of the variables in Z).

A labeled trace of a transition system is a sequence s₁,l₁,s₂,l₂ . . . such that s₁∈I. and ∀ⱼ≧1: Tⱼ(sⱼ,sⱼ₊₁). A trace is a sequence s₁,s₂, . . . such that ∃l₁,l₂; with <s₁,l₁,s₂,l₂ . . . > . . . as a labeled trace. A labeled trace if of finite length will be called a finite (labeled) trace.

M is considered deterministic if:

∀s₁,s₂,s₃∈Γ:T(s₁,s₂) [symbol] s₂|ν_{!}=s₃|ν_{!}

M′s transitions Tₗ are said to be disjoint if:

∀l₁∈range(λ),s₁,s₂∈Γ:T(s₁,s₂) [symbol] Al₂∈range(λ),s₃∈Γ:l₁≠l₂ [symbol] Tₗ₂(s₁,s₃) [symbol] s₂|ν_{!}=s₃|ν_{!}

In general, determinism and disjointness do not imply one-another. But if M is deterministic but its transitions are not disjoint, then the following holds:

∀l₁,l₂∈range(λ),s₁,s₂,s₃∈Γ:Tₗ₁(s₁,s₂) [symbol] Tₗ₂(s₁,s₂) [symbol] s₂|ν_{!}=s₃|ν_{!}

This simplifies the process to generate a deterministic M's transitions disjoint by partitioning S based on such pairs of states that are connected by multiple Tₗₛ, and extending this partitioning to the Tₗₛ that overlap. If M is non-deterministic, a trace of it can correspond to multiple labeled traces.

The model is referred to as an automata which studies abstract machines and computational problems using abstract machines. The automata utilizes states and transitions. The automata described herein utilizes five units (Σ,S,I,δ,F), where Σ is an alphabet, S is a set of states, I⊂S is the set of initial states, F⊂S is the set of final states, and δ∈S×Σ×S is the transition relation. The automata is finite if S is finite. Derivations of the automata are defined as paths from a state in I to a state in F.

For an automata A₁=(Σ,S₁,I₁,δ₁,F₁) and A₁=(Σ,S₂,I₂,δ₂,F₂), a relation H⊂S₁×S₂ is called a simulation relation if for all (s_{1,}s₂)∈H. For every transition from s₁, there is a corresponding transition from s₂, that is the following holds that for all l and s′₁ s.t., (s_{1,}l,s′₁)∈δ₁, _{there exists s′}₂s.t., (s_{2,}l,s′₂)∈δ₂ and (s′₁,s′₂)∈H.

A definition (definition 3) is set such that an automation A₂ is said to be an abstraction of automation A₁, written A₂ [symbol] A₁, when there exists a simulation relation H such that:

for all s₁∈I₁ there exists an s₂∈I₂ s.t., H(s₁,s₂), and

for all s₁,s₂ if s₁∈F₁ and (s_{1,}s₂)∈H then (s₂∈F₂),

A theorem (theorem 1) can be derived as follows: if A₂ [symbol] A₁ and S₁¹,lₗ,s₂¹,l₂, . . . ,sₘ¹(s₁¹∈I₁ and sₘ¹∈F₁) is a derivation A₁, then there exists a corresponding derivation s₁²,l₁,s₂²,l₂, . . . ,sₘ² in A₂). Therefore, when A₂ [symbol] A₁,A₂ is often called an existential abstraction of A₁, since any derivation of A₁ is also guaranteed to exist in A₂.

Given the automata, the transition system M, and the set of states F⊂S, a determination is made whether F is reachable in M. If F is reachable, a witness trace is returned. F will be given as a predicate on V, but F can also be denoted as a subset of S. Therefore, F is denoted as either a predicate or the corresponding set.

The objective is to find a path in a possibly infinite state automata A_{M,F}, where A_{M,F}Δ(range(λ),S,I,δ,F) and δ(s₁,l,s₂) [symbol] Tₗ(s₁,s₂). It should be understood that every finite labeled trace of the transition system M ending is a state in F is a path (derivation) of A_{M,F}, and vice versa.

Once the automata has been defined, the predicate abstraction of the transition system models are considered. The abstract models are a finite state automata related to A_{M,F} via [symbol] . To do so, assumptions are made such I≠0 and F≠0. If this were not true, then there would be no problem to solve. Secondly, I∩F≠0. If this were not true, then the problem could be trivially solved. The abstract model will be defined in terms of a set of abstract states \tilde{S} and its connection with S, which is the state space of the concrete model since abstract models are defined in terms of partitions of the state space of the concrete model.

A definition (definition 4) is set so that a partition of S is a tuple (\tilde{S},α) such that \tilde{S} is a set and α:S→\tilde{S} is an onto map. For a partition (\tilde{S},α) we define b:S→2^{s} as β(\tilde{s}). Note that β(\tilde{s})can also be expressed as a predicate on the variables V. The partition (\tilde{S},α) will be denoted (\tilde{S},b).

An abstract model can be viewed as a finite state automata (FSA) that is defined in terms of partition. Given a partition (\tilde{S},α) of S, the corresponding FSA abstract model is defined as fsa(α)Δ(range (λ),\tilde{S},Ĩ,\tilde{δ},\tilde{F}) where:

ĨΔ{\tilde{s}|β(\tilde{s}) [symbol] I}

\tilde{F}Δ{\tilde{s}|β(\tilde{s}) [symbol] F}

It is possible that \tilde{F}=0, which would mean that the abstraction is useless. To prevent, at least one of the elements of the partition is needed, β(s), to be such that in implies F. A natural way to achieve this is to ensure that the partition (\tilde{S},α) respects F (i.e., any element of the partition either contains no element from F of all the element are from F. A most simplistic way to realize this is to keep F itself as one of the partitions. As a result, \tilde{δ} captures the possibility of a transition in M such that:

\tilde{δ}(\tilde{s}₁,l,\tilde{s}₂) [symbol] ∃s₁∈β(\tilde{s}₁),s₂∈β(\tilde{s}₂):Tₗ(s₁,s₂)

As a result, the following Theorem (theorem 2) can be derived:

$$fsa ( {α}^{0} ) \geq {α}^{0} , {β}^{0} {\tilde{A}}_{M , F} .$$

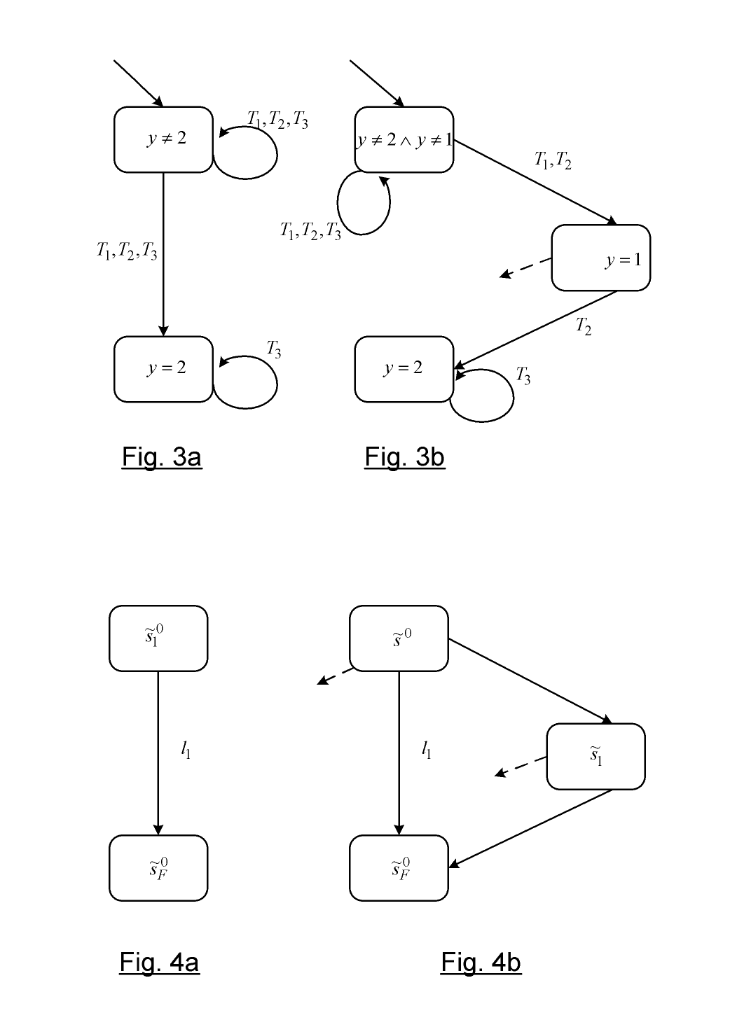

From the fact that {(s,α(s))|s∈S} forms a simulation. fsa(α) is thus an existential abstraction of A_{M,F}. For example FIG. 2 shows a transition system, FIG. 3a shows an initial abstraction for FIG. 2, and FIG. 3b is its refinement. From Theorem 1, the following is derived:

For an FSA Ã [symbol] A_{M,F}, the abstract path corresponding to a concrete path s₁,l₁,s₂,l₂, . . . is α(s₁),l₁,α(s₂),l₂, . . . , and if sᵢ∈F then the corresponding α(s₁)∈\tilde{F}.

For an automation Ã as per definition 5, the following can also be derived Ã [symbol] _{α,β}A_{M,F}.

The following definition (definition 6) can also be determined. In an abstraction Ã, for any triple \tilde{t}= [symbol] \tilde{s}₁l\tilde{s}₂ [symbol] (\tilde{s}₁,s₂∈\tilde{S}, and l∈ range(λ)):

\tilde{t} is a valid transition if ∃s₁∈β(\tilde{s}₁),s₂∈β(\tilde{s}₂):Tₗ(s₁,s₂);

\tilde{t} is an impossible transition if not ∃s₁∈β(\tilde{s}₁),s₂∈β(\tilde{s}₂):Tₗ(s₁,s₂);

\tilde{t} is an always valid transition if ∀s₁∈β(\tilde{s}₁):∃s₂∈β(\tilde{s}₂):Tₗ(s₁,s₂).

Note that the relation \tilde{δ} includes precisely the set of all valid transitions. The notion of always valid transitions will be useful in a sequel.

To check reachability of a F in the transition system M, a counter-example guided abstraction refinement (CEGAR) based technique is used, particularly in Simulink models. Algorithm 1, as shown below, illustrates a basic CEGAR approach to check reachability of F in the transition system M. The initial abstraction can be any automation built, as per definition 5, from a partition of the state space.

Algorithm 1

```
Input: M ≡ (V,I,T) a concrete model, F a set of states of M.
Output: (r,τ) a pair, where r is a Boolean and τ is an execution path of M
(\tilde{S}₀,β₀) := a partion of S (that respects F)
Ã₀ := fsa (β₀);
p := 0;
while true do
      Ãₚ ≡ (L,\tilde{S}ₚ,Ĩₚ,\tilde{δ}ₚ,\tilde{F});
      σₚ := findpath(Ãₚ);
      if σ = NULL then
            return(false,NULL);
      (b,τ,stp) := checksimulation(M,σₚ,βₚ);
      if b then
            return(true,τ)
      stp ≡ (\tilde{s}_{b},l,\tilde{s}ₑ)
      l* Partitioning,to compute new partition*/
      Sₚ₊₁ := Sₚ − {\tilde{s}_{b}} ∪ {\tilde{s}_{b1},\tilde{s}_{b0}};
      βₚ₊₁ := partition(βₚ,stp,\tilde{s}_{b1},\tilde{s}_{b0});
      l* Computing new initial states*/
      if \tilde{s}_{b} ε Ĩₚ then
            Ĩₚ₊₁ := Ĩₚ − {\tilde{s}_{b}};
            if (β_{P+1}(\tilde{s}_{b0}) ∩ I ≠ φ)then Ĩₚ₊₁ := Ĩₚ₊₁ ∪ {\tilde{s}_{b0}};
            else Ĩₚ₊₁ := Ĩₚ₊₁ ∪ {\tilde{s}_{b0}};
      else
            Ĩₚ₊₁ := Ĩₚ;
      l* Computing new transition relation*/
      \tilde{δ}ₚ₊₁ := recompute(Ãₚ,M,βₚ₊₁,Sₚ₊₁);
      Ãₚ₊₁ := (L,\tilde{S}ₚ₊₁,Iₚ₊₁,\tilde{δ}ₚ₊₁,\tilde{F});
      p := p + 1;
end
```

The steps used in algorithm 1 are described herein. A findpath takes an automata Ã as an argument and returns a derivation σ, which is NULL if there is no derivation of Ã. If there is a derivation of Ã, then σ=\tilde{s}₁,l₁,\tilde{s}₂ . . . , \tilde{s}ₙ such that s₁∈Ĩ,sₙ∈\tilde{F}, and sᵢ∉\tilde{F} for i<n. This technique involves only a graph search. The automata Ã is viewed as a graph with its states being nodes, and transitions being edges. The objective is to find and return a path in the graph from a node in Ĩ to a node in \tilde{F}. It should be understood that the set of final states \tilde{F} is the same throughout. This is valid because a path is always chosen that contains a state in \tilde{F} only as a last state.

The next step is a checksimulation which checks if there is a valid finite labeled trace of M (e.g., a path in A_{M,F}) corresponding to σ. For σ [symbol] \tilde{s}₁,l₁,\tilde{s}₂ . . . , \tilde{s}ₙ (\tilde{s}₁∈Ĩ and \tilde{s}ₙ∈\tilde{F}), a check made whether there is a trace of M of the form \tilde{s}₁,l₁,\tilde{s}₂,l₂ . . . , \tilde{s}ₙ such that ∀1≦i≦n:sᵢ∈β(\tilde{s}ᵢ). If there is a trace τ, then the procedure returns [symbol] true,τ,_ [symbol] . If there is no such trace, then the procedure returns [symbol] false,_, [symbol] ,\tilde{s}ₖ,lₖ,\tilde{s}ₖ₊₁ [symbol] , where k is the smallest index j(1≦j≦n) such that there is no trace of M of the form s₁,l₁,s₂,l₂ . . . ,sⱼ₊₁ with ∀1≦i≦n:sᵢ∈β(\tilde{s}ᵢ). The checksimulation as described herein is iteratively shown in the algorithm 2 shown below:

Algorithm 2: Procedure checksimulation

```
Input : M a concrete model,σ an abstract trace
Output : [symbol]   b,τ,stp [symbol]
Let σ[i]= [symbol]   \tilde{s}ᵢ,lᵢ,\tilde{s}ᵢ + 1 [symbol]   ;
assert(I [symbol]   β(\tilde{s}₁));
i:=1;
while i≦length (σ) − 1do;
        assert(step(Tₗᵢ,i − 1));
        assert(step(β(\tilde{s}ᵢ₊₁),i)); [symbol]
        b,τ [symbol]   :=check( );
        if [symbol]   b then
            return [symbol]   false,NULL,σ[i] [symbol]
end
return [symbol]   true,τ,NULL [symbol]   ;
```

In Algorithm 2, the assert (P) means the predicate of P is assumed. Routine check( ) indicates whether the predicates that have been assumed as of that point in time are satisfied. For a σ as described above, will indicate that there are n−1 iterations, and a number of n calls to a suitable decision procedure.

The predicates that are asserted are drawn from M. It should be understood that variable occurrences in the predicates have to renamed in some manner. For example, if variable υ occurs in β(\tilde{s}₁) and β(\tilde{s}₂), these occurrences correspond to values of vat different steps, and more particularly, that these values could be connected by the transition predicate Tₗ_{₁}. These predicates are asserted such that distinct occurrences and the connections are accounted for correctly. This is accounted for using a renaming scheme based on indices into the path of interest σ. This is formalized using the function step show at lines 5-6 in the algorithm shown in Algorithm 2.

A next definition (definition 7) is derived. Definition 7 states that xx returns a formula that is the same as xx but with every variable occurrence replaced by an occurrence of the same variable for xx steps further ahead.

It is noted that if a particular [symbol] \tilde{s}ₖ, lₖ, \tilde{s}ₖ₊₁ [symbol] is an always valid transition, that its validity check shown at lines 8-10 in FIG. 2 is unnecessary. Therefore, if this information is known without checking for it and without the overhead of maintaining it, then computation time and power is saved since a decision procedure check is not required. As a result, this is exploited in optimizing the reachability technique.

The next step is a partition which is represented by β [symbol] (\tilde{s}_{b},l,\tilde{s}ₑ) [symbol] ,\tilde{s}_{b1},\tilde{s}_{b0}. The partition returns the modified map β′, which is computed as follows:

Pᵣ₁=β(\tilde{s}_{b}) [symbol] Pre(β(\tilde{s}ₑ),Tₗ)

Pᵣ₁=β(\tilde{s}_{b}) [symbol] Pre(β(\tilde{s}ₑ),Tₗ)

β′:=β−{\tilde{s}_{b} [symbol] _{—}}∪{\tilde{s}_{b1} [symbol] Pr₁,\tilde{s}_{b0} [symbol] Pr₀}

where

Pre(X,Tₗ) [symbol] step(X,1) [symbol] Tₗ⁴

Pre(X,Tₗ) captures the condition taking the transition Tₗ, the model M can be in some state in X. Then, [symbol] Pre(X,Tₗ) captures the condition taking the transition Tₗ, the model M is guaranteed not to be in some state in X. If model M is deterministic, then Pre is equivalent to the weakest-precondition, i.e., from any state in Pre(X,Tₗ) transition Tₗ is guaranteed to result in a state in X. In general, for the weakest pre-condition WP(X,Tₗ) [symbol] step(X,1) [symbol] Tₗ [symbol] (step( [symbol] X ,1) [symbol] T)⁵, where the second term takes care of possible non-determinism. If model M is deterministic, then this term will be true, and thus Pre and WP are identical.

A next definition (definition 8) may derived as follows. New states \tilde{S}_{b1} where Pre with respect to the failed transition is true will be called the true-partition with respect to [symbol] \tilde{s}_{b},l,\tilde{s}ₑ [symbol] , and the new state \tilde{s}_{b0} where Pre with respect to the failed transition is false will be called the false-partition with respect to [symbol] \tilde{s}_{b},l,\tilde{s}ₑ [symbol] . It is noted that if an abstract state \tilde{s}∈\tilde{S} is the false-partition with respect to some [symbol] \tilde{s}_{b},l,\tilde{s}ₑΛ, then [symbol] \tilde{s}_{b},l,\tilde{s}ₑ [symbol] is an impossible transition. Similarly, if an abstract state \tilde{s}∈\tilde{S} the true-partition with respect to some [symbol] \tilde{s}_{b},l,\tilde{s}ₑ [symbol] and if [symbol] \tilde{s}_{b},l,\tilde{s}ₑ [symbol] is deterministic, then [symbol] \tilde{s}_{b},l,\tilde{s}ₑ [symbol] is always a valid transition. It should also be noted that a deterministic M does not mean that the abstract FSAs Ãₚ are deterministic. Rather the FSAs Ãₚ are invariably non-deterministic.

The next step is a recompute represented by (Ã,M,β′,S′). In a recompute, the routine returns a transition relation δ′ over the new set of abstract states S′. From definition 5, it should be clear that for \tilde{s}₁,\tilde{s}₂∈S′, \tilde{δ}′(\tilde{s}₁,l,\tilde{s}₂) [symbol] ∃s₁∈β′(\tilde{s}₁),s₂∈β′(\tilde{s}₂):Tₗ(s₁,s₂). In practice, [symbol] (\tilde{s}₁,l,\tilde{s}₂) [symbol] is added to δ′ whenever Pre(β′(\tilde{s}₂),Tₗ) [symbol] β′(\tilde{s}₁) is unsatisfiable (i.e., if [symbol] (\tilde{s}₁,l,\tilde{s}₂) [symbol] is a valid transition).

The recompute step computes a succession of FSAs Ã₀,Ã₁, . . . ,Ãₚ. The following is a possible result obtained for the algorithm. For every (\tilde{S}ₚ,βₚ) produced by algorithm 1 is a partition. That is, by induction of the sequence Ã₀,Ã₁, . . . ,Ãₚ . . . , the base case is not true trivially (from line 1 of Algorithm 1). For the induction step, assume (\tilde{S}ₚ,βₚ) is a partition. (\tilde{S}ₚ₊₁) is obtained by partitioning one of the states of \tilde{S}ₚ (lines 13-14 of Algorithm 1) and hence it is also a partition of S.

As a result, the following theorem (3) may be derived: every Ãₚ is produced by algorithm 1 satisfies Ãₚ [symbol] αₚ,βₚÃ_{M,F}, where (\tilde{S}ₚ,βₚ) is a partition of S. Ãₚ is obtained by computing its transition relation as per definition 5. Therefore, from Theorem 2, this is a valid transition.

The following theorem (4) may be derived: Ãₚ [symbol] Ãₚ₊₁, for p≧0; (4) if M is deterministic and is transition are disjoint; the first part of the theorem may be proved. Consider a map

H⊂Sₚ₊₁×\tilde{S}ₚ [symbol] {(\tilde{s},\tilde{s})|\tilde{s}≠\tilde{s}_{b} [symbol] \tilde{s}≠\tilde{s}_{b0} [symbol] \tilde{s}≠\tilde{s}_{b0} [symbol] \tilde{s}≠\tilde{s}_{b1}}∪{(\tilde{s}_{b0},\tilde{s}_{b}),(\tilde{s}_{b1},\tilde{s}_{b}).

It is a simulation since for all (\tilde{s}′,\tilde{s})∈H, every transition from \tilde{s}′ in Ãₚ₊₁ has a corresponding transition from \tilde{s} in Ãₚ (due to recompute). It is also satisfies the condition of definition 3 (lines 15-20 of Algorithm 1) and hence the results hold.

The second part follows from the fact that there exists no simulation relation H⊂Sₚ₊₁×\tilde{S}ₚ. If M is deterministic and its transitions are disjoint, then for any Ãₚ(p≧1) and for the state s∈Sₚ that is the true-partition that was introduced in Ãₚ with respect to some [symbol] (\tilde{s}_{b},l,\tilde{s}ₑ) [symbol] of Ãₚ₋₁, then the following are true:
(1) s̅ has exactly one transition out of it (i.e., |δₚ( s̅,_,_)|=1 , and it is [symbol] (\tilde{s}_{b},l,\tilde{s}ₑ) [symbol] .
(2) [symbol] (\tilde{s}_{b},l,\tilde{s}ₑ) [symbol] is always a valid transition.
(3) s̅ will not be partitioned in any of the FSAs Ãₚ(q≧p).

For any Ãₚ, if the partition is on the first state of the abstract path then, the false-partition will be an initial state in Ãₚ₊₁ and the true-partition will not be partitioned. That is, for σ=\tilde{s}₁,l,\tilde{s}₂, . . . ,sₙ, if the partition is on [symbol] (\tilde{s},l,\tilde{s}ₑ) [symbol] , then the false partition \tilde{s}₁₀ will be in Ĩₚ₊₁ and the true-partition \tilde{s}₁₁ will not be in Ĩₚ₊₁.

The following is a proof. It is obvious that \tilde{s}₁ is an initial state of Ãₚ₊₁. Assume that \tilde{s}₁₁ is an initial state of Ãₚ₊₁, then from Algorithm 1, lines 17-18, if follows:

I [symbol] βₚ₊₁(\tilde{s}₁₁) is satisfiable;

[symbol]

I [symbol] βₚ(\tilde{s}₁) [symbol] step(βₚ(\tilde{s}₂),1) [symbol] Tₗ is satisfiable.

This implies that the first transition [symbol] \tilde{s}₁,l,\tilde{s}₂ [symbol] of σ was valid in M (lines 1-3 and the first iteration of lines 5-9 of Algorithm 2 checks exactly the above condition). However, this contradicts with the fact that the partition happened on this transition and hence it was found to be infeasible. As a result, the assumption is wrong and \tilde{s}₁₁ is not an initial state of Ãₚ₊. Therefore, since an initial state \tilde{s}₁ was partitioned to obtain \tilde{s}₁₁ and \tilde{s}₁₀, \tilde{s}₁₀ will be an initial state of Ãₚ₊₁.

FIG. 3a illustrates an initial abstraction, and the aim is find a trace to reach the concrete state satisfying a predicate y=2. The routine findpath ( ) produces an abstract trace σ₀=\tilde{s}₁,T₂,s₂. The routine checksimulation ( ) finds if this is a valid trace in the concrete model. The computations are as follows:

assert(I [symbol] β(\tilde{s}))=x=0 [symbol] y≠2

assert(step(T_{2,}0))=y<2=0 [symbol] y′=y+1

assert(step(β(\tilde{s}₂),1)=y′=2

Routine check ( ) finds that the above constraints are unsatisfiable. For the refinement, node \tilde{s}₁ is split to produce states \tilde{s}₁₀ and \tilde{s}₁₁.

Pre(β(\tilde{s}₂),T₂)=step(β(\tilde{s}₂),1) [symbol] T₂=y′=2 [symbol] y′=y+1

i.e., Pre(β(\tilde{s}₂),T₂)=y+1

i.e., β(\tilde{s}₁₁)=y=1 [symbol] y≠2 and β(\tilde{s}₁₀)=y≠1 [symbol] y≠2

FIG. 3(b) illustrates a refined model. The routine recompute ( ) computes the transitions of the refined model. In the next iteration, the new abstract trace is σ₀=\tilde{s}₁₀,T₁,s₁₁,T₂,\tilde{s}₂. Thereafter, a checksimulation ( ) performs the following computations:

assert(I [symbol] β(\tilde{s}₁0))=x=0 [symbol] y≠1 [symbol] y≠2

assert(step(T₁,0))=x=0 [symbol] x′=x+1 [symbol] y′=y=+1

assert(step(β(\tilde{s}₁₁),1)=y′=1 [symbol] y′≠2

assert(step(T_{2,}1))=y′<2 [symbol] y″=y¹+1

assert(step(β(\tilde{s}₂),2)=y″=2

The above assertions are satisfiable, which indicates that a trace to the desired state in the concrete model is found.

In Algorithm 1, the partition used to define the initial abstraction was left unspecified (e.g., line 1). The unspecified partition is corrected and the consequences of the algorithm are derived. The assumptions are that (1) the transition T is deterministic, and (2) a findpath always selects an acrylic path. For a given set of states F, the partition) (\tilde{S}⁰,β⁰) is defined as follows:

\tilde{S}⁰={s_{I}⁻⁰,s_{F}⁻⁰}

β⁰=(s_{I}⁻⁰)= [symbol] F

β⁰=(s_{F}⁻⁰)=F

### That is,

$${α}^{0} ( s ) = \{ \begin{matrix}{s}_{I}^{- 0} & if s ∉ F \\ {s}_{F}^{- 0} & if s ∈ F\end{matrix} \} .$$

An existential abstraction fsa(α⁰) is obtained by applying the following definition to the partition) (\tilde{S}⁰,β⁰). The following is a result from Theorem (2):

$$fsa ( {α}^{0} ) \geq {α}^{0} , {β}^{0} {\tilde{A}}_{M , F} .$$

Algorithm 1 is considered (\tilde{S}⁰,α⁰)with as the initial partition at line 1. A number of observations can be made regarding the FSAs Ãₚ computed by the algorithm. These observations are analyzed as follows:

Algorithm 1 is applied with the model fsa(α⁰) as Ã₀. Then in the first iteration of the loop (p=0), a path σ₀ (if it exists) will be of the form s_{I}⁻⁰,l₁,s_{F}⁻⁰ as shown in FIG. 4a. If this is infeasible, then the start state of σ₀ will be partitioned (i.e., the initial state s_{I}⁻⁰. This will provide two new states, a false partition \tilde{s}₀ and a true-partition \tilde{s}₁. \tilde{s}₀ will become the new initial state. \tilde{s}₁ will have only a single transition out of it, namely s_{I}⁻⁰,l₁,s_{F}⁻⁰, and this will always be valid in M. As a result, this generates a new FSA Ã₁, in which there are two kinds of acrylic paths possible to s_{F}⁻⁰ as shown in FIG. 4b, \tilde{s}₀,l₂,\tilde{s}₁,l₂,s_{F}⁰ or \tilde{s}₀,l₃,s_{f}⁻⁰ (for some l₂,l₃). In both instances, the start state (and initial state) \tilde{s}₀ will be partitioned in case the path is infeasible, and the new initial state (of Ã₂) will again be the false-partition while the true-partition will have a single valid transition out (i.e., that either to s_{F}⁻⁰ or to the other true-partition state \tilde{s}₁). The models Ãₚ all have initial and final state sets as singletons, and that the refinement always happens on the start state of an acyclic path (that is also the initial state). Ãₚ also has the property that all the states apart from the initial and final states are true-partitions. The validity of the acrylic path is checked and only the first transition has to be checked.

In Theorem (5), the assumption is for any Ãₚ,Ĩₚ, and \tilde{F}ₚ are singletons. This can proved by induction sequence Ã₀ . . . ,Ãₚ. The base case p=0 is trivially true from construction of (\tilde{S}⁰,α⁰). Consider an induction step. Assume that the result holds for Ãₚ. Then Ãₚ₊₁ is obtained by partitioning exactly one state \tilde{s}_{b} (into true-partition \tilde{s}_{b1} and false-partition \tilde{s}_{b0}) of Ãₚ to get \tilde{S}ₚ₊₁,βₚ₊₁. If \tilde{s}_{b} is not the initial state of Ãₚ, then neither of the new states is an initial state (lines 15-20 of Algorithm 1), and hence the result holds of Ãₚ₊₁. If \tilde{s}_{b} is the initial state of Ãₚ, and since only acyclic paths are chosen and since \tilde{s}_{b} is the only initial state of Ãₚ, then \tilde{s}_{b} is the first state on the abstract path σₚ. It is clear that only the false-partition \tilde{s}_{b0} will be an initial state of Ãₚ₊₁ and thus Ĩₚ₊₁ is a singleton. Regarding the final state, since Ãₚ has only one final state, this will necessarily occur as the last state on the path σₚ, and will never be split. Therefore, Ãₚ₊₁ will have the same unique final state as Ãₚ. The result holds for Ãₚ₊₁.

In going forward, the state of Ãₚ will only be referred to as ĩₚ, while only the final state will be s_{F}⁻⁰ (since it was shown above that the final state of Ãₚ₊₁ is the same unique final state as Ãₚ, and the final state is Ã⁰'s final state.

Theorem (6) states that for any Ãₚ, each non-initial non-final abstract states corresponds to a true-position (introduced in some Ã_{q}, 1≦q≦p). This can be proved by induction on the sequence Ã₀ . . . ,Ãₚ . . . . The base case (p=0) is trivially true from construction of (\tilde{S}⁰,α⁰), which has no non-initial non-final states. Consider an induction step. Assume that the result holds for Ãₚ. Then from the assumption (theorem 5), we also know that the σₚ has a unique initial state ĩₚ and a unique final state s_{F}⁻⁰. Then any acyclic path σₚ that we choose in Algorithm 1 begins with ĩₚ, ends with s_{F}⁻⁰, and has all intermediate states (if any) as true-partition states. It is readily understood that all transitions in σₚ except the first are always valid transitions. This means that if σₚ is infeasible, then it is because of the next transition (i.e., this is what checksimulation will return as stp) and hence the portioning will happen on the start state ĩₚ. It is clear that among the new states, the false-partition will become the new initial state (of Ãₚ₊₁). The result holds for Ãₚ₊₁.

In both the above proofs, the induction step will go through regardless of what the initial abstraction was (it requires only deterministic M). This means that any initial partition that has the above properties will suffice. The simplest partition is selected.

Theorem (7) states that for any acyclic path σₚ in Ãₚ, all the transitions except the first are always valid transitions.

Theorem (8) states that for any Ãₚ and any acyclic path σₚ, the partitioning, if any, will happen on ĩₚ and moreover as the first abstract state of σₚ. This is proved in that partition will be on ĩₚ is a corollary of Theorem 7. For acyclic paths σₚ, the unique initial state ĩₚ occurs only as the first state on the path (from Theorem 5). Therefore, since ĩₚ will be partitioned, the partition is always on the first state for acyclic σₚ.

Based on the above results, the following improvements are possible for the algorithm.

Improvement (A): based on theorem 6, Ãₚ only needs to choose a non-loop edge out of the node corresponding to ĩₚ in the graph corresponding to Ãₚ. The rest of the path is uniquely determined. This simplifies findpath.

Improvement (B): from theorem 8, the recomputation of initial state after partition is trivial, and is always a false-partition. This means lines 15-20 of Algorithm 1 can be replaced y a single assignment, and this saves a decision procedure call (at line 17).

Improvement (C): from theorem 7, it is clear that checksimulation (8xx) needs to check the validity of only the first transition of σₚ. This means that a number of decision procedure check calls from length σₚ to 1 can be reduced. This should result in significant performance improvements in practice, since the decision procedure checks are always the most expensive part of the algorithm.

Algorithm 3 provides a revised version of the basic algorithm given earlier as Algorithm 1 incorporating improvements as described above. Algorithm 3 is as follows:

Algorithm 3: CEGAR based reachability - revision 1

```
Input : M a concrete model,F a set of states of M
Output :(r,τ) a pair,where r is a boolean and τ is an execution path of M
        Ã₀ := fsa(α⁰);
        p:=0;
        while true do
        Ãₚ ≡ (L,\tilde{S}ₚ,{\tilde{ι}ₚ},{\tilde{s}_{F}⁰});
        σₚ := findpath_1(Ãₚ);
        if σₚ := NULL then
            return (false,NULL) [symbol]
        b,τ [symbol]   := checksimulation_1(M,σₚ,βₚ);
        if b then
            return (true,τ)
        stp≡Then first transition of σₚ,say [symbol]   \tilde{s}_{b},l,\tilde{s}ₑ [symbol]   ;
        \tilde{S}_{P+1} := \tilde{S}ₚ − {\tilde{s}_{b}}∪{\tilde{s}_{b1},\tilde{s}_{b0}};
        β_{P+1} := partition(βₚ,stp,\tilde{s}_{b1},\tilde{s}_{b0});
        Ĩ_{P+1} := Ĩₚ − {\tilde{s}_{b}}∪{\tilde{s}_{b0}};
        \tilde{δ}_{P+1} := recompute(Ãₚ,M,βₚ₊₁,Sₚ₊₁);
        Ã_{P+1} := (L,\tilde{S}ₚ₊₁,Ĩₚ₊₁,\tilde{δ}ₚ₊₁,\tilde{F});
        p:= p + 1;
end
```

The process starts with the abstraction fsa(α⁰). The process uses the procedure findpath_{—}1 (Algorithm 4) revised from findpath as per improvement (A). Algorithm 4 is as follows:

Algorithm 4: Procedure findpath_1

Input : Ã is FSA
Output :σ a path(derivation) of Ã
Ã ≡ (L,S,{\tilde{ι}},δ,{\tilde{s}_{F}⁰};
/* choose a transition out of the initial state
e := [symbol] \tilde{ι},l,\tilde{s} [symbol] s.t.,(s ≠ \tilde{ι}) if it exists; else NULL;
If e = NULL, then
return NULL
σ := [e]
/* extend the path to the final state
x = \tilde{s};
while x ≠ \tilde{s}_{F}⁰ do
σ := σ · [symbol] x,_,y [symbol] ;
x:=y;
end
return σ;

Algorithm 5 describes a procedure checksimulation_{—}1 (revised from algorithm 2) incorporating the improvement from Improvement (C). Finally as per Improvement (B), the re-computation of the initial state is simplified (i.e., line 14). The procedure partition and recomputed remain unchanged from earlier. Algorithm 5 is as follows:

Algorithm 5: Procedure checksimulation_1

```
Input : M a concrete model,σ an abstract trace
Output : [symbol]   b,τ [symbol]
Let σ[i]≡ [symbol]   \tilde{s}ᵢ,lᵢ,\tilde{s}ᵢ₊₁ [symbol]   ;
assert(I [symbol]   β(\tilde{s}ₗ) [symbol]   Tₗ_{₁});
assert(step(β(\tilde{s}₂),1)); [symbol]
b,τ [symbol]   :=check( );
if [symbol]   b then
          return [symbol]   false,NULL [symbol]
          /*The rest of σ will be valid,with τ as witness.*/
return [symbol]   true,τ [symbol]   ;
```

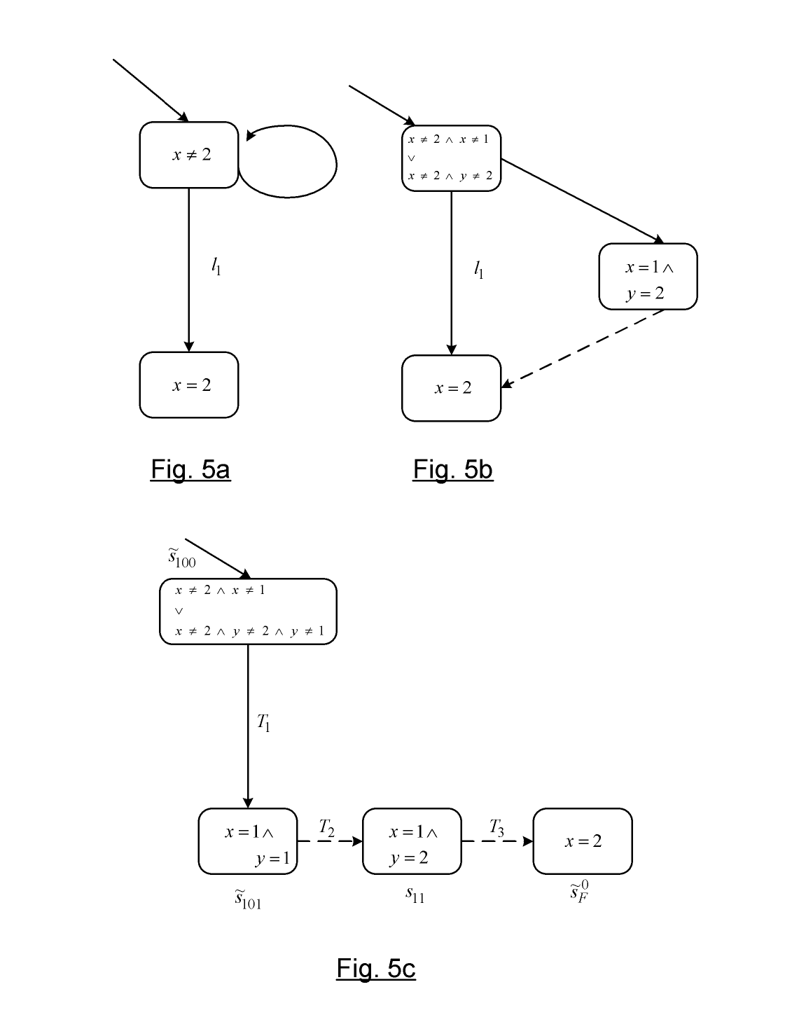

In reference to FIG. 5 which is a two-state abstraction of the transition system in FIG. 2, the final state is s_{F}⁻⁰ with predicate x=2 and the initial state \tilde{s}₁ is denoted by predicate x≠2 as shown in FIG. 5a. The abstract trace to reach the final state is [symbol] \tilde{s}₁,T₃,\tilde{s}_{F}⁰ [symbol] . This is not satisfiable in the concrete since the transition [symbol] T₃ [symbol] cannot go from x≠2 to x=2 in the concrete. FIG. 5b is the abstract model obtained by refinement (i.e., the initial state \tilde{s}₁ is spit to produce \tilde{s}₁₁ and \tilde{s}₁₀). The transition from \tilde{s}₁₁ to \tilde{s}_{F}⁰ is an always valid transition. Next findpath_{—}1 determines the abstract trace as * is the abstract transition to reach the final state. Since the first transition in this trace is unsatisfiable in the concrete, it implies that the whole trace is unsatisfiable. Hence the initial state \tilde{s}₁₀ is split to produce the new states \tilde{s}₁₀₁ and \tilde{s}₁₀₀, and the abstraction is shown in FIG. 5c. Findpath_{—}1 finds the new abstract trace as: [symbol] \tilde{s}₁₀₀,T₁,\tilde{s}₁₀₁,T₂,\tilde{s}₁₁,T₃,\tilde{s}_{F}⁰ [symbol] . Since the first transition of this abstract trace is satisfiable in the concrete it implies that the whole abstract trace is satisfiable in the concrete.

A simplier variant of recomputed is described herein that provides a coarser abstraction refinement but requires no decision procedure calls. Since this refinement produces an automation that includes all paths in the automation that is produced by the original refinement, the algorithm remains sound. The technique also makes use of the fact that the check that is used to add a transition in recomputed. The transition used in the checksimulation are essentially the same to show this coarser refinement will take a lesser number of decision procedure calls as compared to the basic recomputed which is the advantage of this method. Algorithm 6 provides a new technique that makes use of the concept described above. Algorithm 6 is as follows:

Algorithm 6: CEGAR based reachability - revision 3

```
Input : M a concrete model, F a set of states of M
Output : [symbol]   b,τ [symbol]   a pair, where r is a Boolean and τ is an execution
path of M
Ã₀:= fsa(α⁰);
p:=0;
while true do
      Ãₚ ≡ (L,\tilde{S}ₚ,{\tilde{ι}ₚ},\tilde{δ}ₚ{\tilde{s}_{F}⁰});
      σₚ := findpath_1(Ãₚ);
      if σₚ := NULL then
            return (false,NULL) [symbol]
      b,f,τ [symbol]   := checksimulation_3(M,σₚ,βₚ);
      if b then
            return (true,τ)
      stp≡Then first transition of σₚ,say [symbol]  \tilde{s}_{b},l,\tilde{s}ₑ [symbol]   ;
      if f then
            βₚ₊₁ := βₚ;
            Ã_{P+1} := (L,\tilde{S}ₚ,Ĩₚ,\tilde{δ} − {(\tilde{s}_{b},l,\tilde{s}ₑ)}\tilde{F});
            p:= p+1;
            continue;
      end
      \tilde{S}_{P+1} := \tilde{S}ₚ − {\tilde{s}_{b}}∪{\tilde{s}_{b1},\tilde{s}_{b0}};
      β_{P+1} := partition(βₚ,stp,\tilde{s}_{b1},\tilde{s}_{b0});
      Ĩ_{P+1} := Ĩₚ − {\tilde{s}_{b}}∪{\tilde{s}_{b0}};
      \tilde{δ}_{P+1} := recompute(Ãₚ,M,βₚ₊₁,Sₚ₊₁,\tilde{s}_{b},\tilde{s}ₑ,\tilde{s}_{b0},\tilde{s}_{b1},l);
      Ãₚ₊₁ := (L,\tilde{S}ₚ₊₁,Iₚ₊₁,\tilde{δ}ₚ₊₁,\tilde{F});
      p := p + 1;
end
```

Algorithm 6 differs from Algorithm 3 in two ways. First, Algorithm 6 uses a new variant of checksimulation (checksimulaton_{—}3 shown in Algorithm 7), and second, the refinement approach is different (i.e., lines 11-23 of Algorithm 6 as compared to lines 11-17 of Algorithm 3).

Checksimulation_{—}3 as shown in Algorithm 7 returns a triple [symbol] b, ƒ, τ [symbol] , where b and τ are the same as earlier described. Algorithm 7 is as follows:

Algorithm 7: Procedure checksimulation_3

```
Input : M a concrete model, σ an abstract trace
Output : [symbol]   b,f,τ [symbol]
Let σ[i]≡ [symbol]   \tilde{s}ᵢ,lᵢ,\tilde{s}ᵢ₊₁ [symbol]   ;
assert(β(\tilde{s}ₗ)Tₗ₁ [symbol]   step(β(\tilde{s}₂), 1));
if [symbol]   check( )then
          return [symbol]   false,true,NULL [symbol]
assert(I); [symbol]
b,τ [symbol]   := check( );
if [symbol]   b then
          return [symbol]   false,false,NULL [symbol]
/*The rest of σ will be valid,with τ as witness.*/
return [symbol]   true,_,τ [symbol]   ;
```

Output ƒ is a special Boolean flag that identifies what type of refinement is to be performed. It recognizes the order of asserts of checksimulation_{—}1 into two steps. First, it checks if β(\tilde{s}₁) [symbol] Tₗ_{₁} [symbol] step(β(\tilde{s}₂),1) is satisfiable. This is basically the same as checking if [symbol] \tilde{s}₁,l,\tilde{s}₂ [symbol] is a valid transition or if it is impossible. This is also essentially the same as what recomputed checks. As a result, the technique is making use of this fact to avoid duplicating the check. If this check fails, then checksimulation_{—}3 returns [symbol] false,true,NULL [symbol] . If this check succeeds, then I is asserted and checked again (lines 6-7). This check is identical to line 5 of checksimulation_{—}1. If it fails, then [symbol] false,false,NULL [symbol] is returned. If it succeeds, then σ has a corresponding valid concrete path τ.

During refinement, (i.e., b was false; lines 11-23 of Algorithm 6), if checksimulation_{—}3 had returned ƒ to be true (i.e., the transition was impossible), then it is simply deleted from \tilde{δ}ₚ to get the automata Ãₚ₊₁. If checksimulation_{—}3 had returned ƒ to be false (i.e., the transition is valid but not feasible in M), then refinement (lines 18-23) is as in Algorithm 3 (lines 12-17) except that recompute_{—}3 is called instead of recompute.

Recompute_{—}3 returns a δ′ which is computed as follows:

\tilde{δ}′=\tilde{δ}−{(\tilde{s}₁,l′,\tilde{s}₂)|\tilde{s}₁=\tilde{s}_{b} [symbol] \tilde{s}₂=\tilde{s}_{b})*

[symbol]

{\tilde{s}_{b1},l,\tilde{s}ₑ}

[symbol]

{(\tilde{s}₁,l′,\tilde{s}_{bz})|z=0|1 [symbol] (\tilde{s}₁,l′,\tilde{s}_{b})∈δ}

[symbol]

{(\tilde{s}_{b0},l′,\tilde{s}₁)| [symbol] \tilde{s}_{b},l′,\tilde{s}₁ [symbol] ∈δ [symbol] (\tilde{s}₁=\tilde{s}ₑ [symbol] l′≠l)}

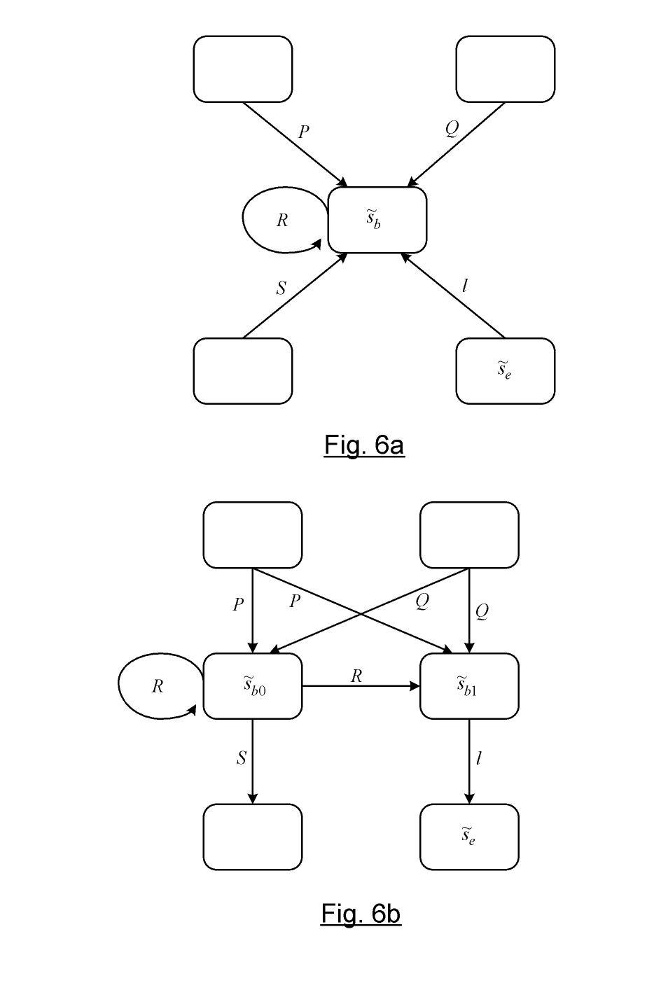

Note that here all the transitions to the old state \tilde{s}_{b} are replicated to the new states \tilde{s}_{b0} and \tilde{s}_{b1}. But for the transition from the old state \tilde{s}_{b0}, the transition on l to \tilde{s}ₑ, is only added from \tilde{s}_{b1}. All others are added only from \tilde{s}_{b0}. This handling of transitions from \tilde{s}_{b} maintains an abstraction while ensuring that the refined FSA will have strictly fewer paths than the original. FIG. 6a shows the situation before refinement and FIG. 6b shows the situation after the refinement. The edges with dotted lines could be added, but edges are not added because the interest is only in acyclic paths in the abstractions and such edges would not way contribute to the acyclic paths.

The following results captures the relevant portions of the algorithm with lazy refinement. First, note that refinement computation of the algorithm implies that the following key result holds:

Every Ãₚ produced by Algorithm 6 is such that Ãₚ [symbol] fsa(\tilde{α}ₚ).

Every Ãₚ produced by Algorithm 6 satisfies Ãₚ [symbol] αₚ,βₚ A_{M,F}.

Ãₚ [symbol] Ãₚ₊₁, for p≧0.

Finally, it is noted that the above method is expected to require fewer decision procedure check calls than the original algorithm (i.e., Algorithm 3) to find a new feasible witness path. Recompute_{—}3 does not require any decision procedure calls, while recompute will require a decision procedure call for each element in the two sets in the last two lines of equation (8) to weed out impossible transitions. In Algorithm 7, this weeding out occurs due to the first check call of checksimulation_{—}3 and the consequent action taken at lines 12-17 of Algorithm 6. Thus, each call to checksimulation_{—}3 has an extra call to the decision procedure compared to checksimulation. But the simple observation is that by deferring the check of validity of a transition until check is actually explored, in practice a number of these calls can be avoided since a feasible path might be found on a branch before a number of others are explored which is advantageous.

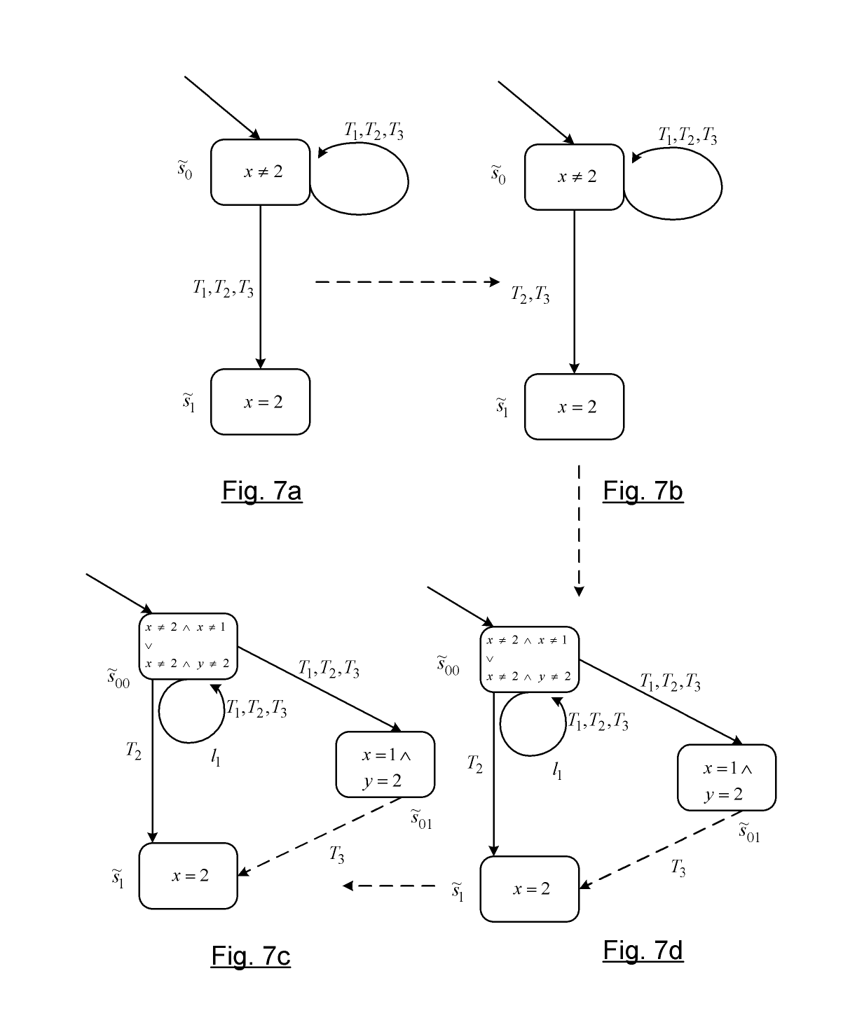

Consider the transition system in FIG. 2. FIG. 7(a) is its two-state abstraction according to the lazy refinement strategy. The decision procedure calls for computing the existential abstraction is desirable to be avoided. Therefore, all possible edges have been added in the initial abstraction. Let [symbol] \tilde{s}₀,T₁,\tilde{s}₁ [symbol] be the initial abstract tract. T₁ is infeasible in any state with x≠2 and hence checksimulation_{—}3 returns [symbol] false,true,NULL [symbol] . As a result, refinement happens in lines 13-15 of Algorithm 6, and the transition T₁ is removed from \tilde{s}₀ to \tilde{s}₁ in the abstraction (transition removal). FIG. 7(b) shows this situation. Next, [symbol] \tilde{s}₀,T₃,\tilde{s}₁ [symbol] is an abstract tract to reach the final state and T₃ here is feasible from x≠2 to x=2, but the transition is infeasible since it does not satisfy the initial condition (x=0 [symbol] y=0). Hence, checksimulation_{—}3 returns [symbol] false,false,NULL [symbol] and therefore abstract state \tilde{s}₀ is split into the two new states \tilde{s}₀₀ and \tilde{s}₀₁ (node splitting). For recomputing the new transitions connecting these nodes, recomputed_{—}3 is followed and the resulting situation is shown in FIG. 7(c). The next abstraction trace is chosen and this continue until a concrete trace to the desired state is determined or the process is aborted because of divergence.

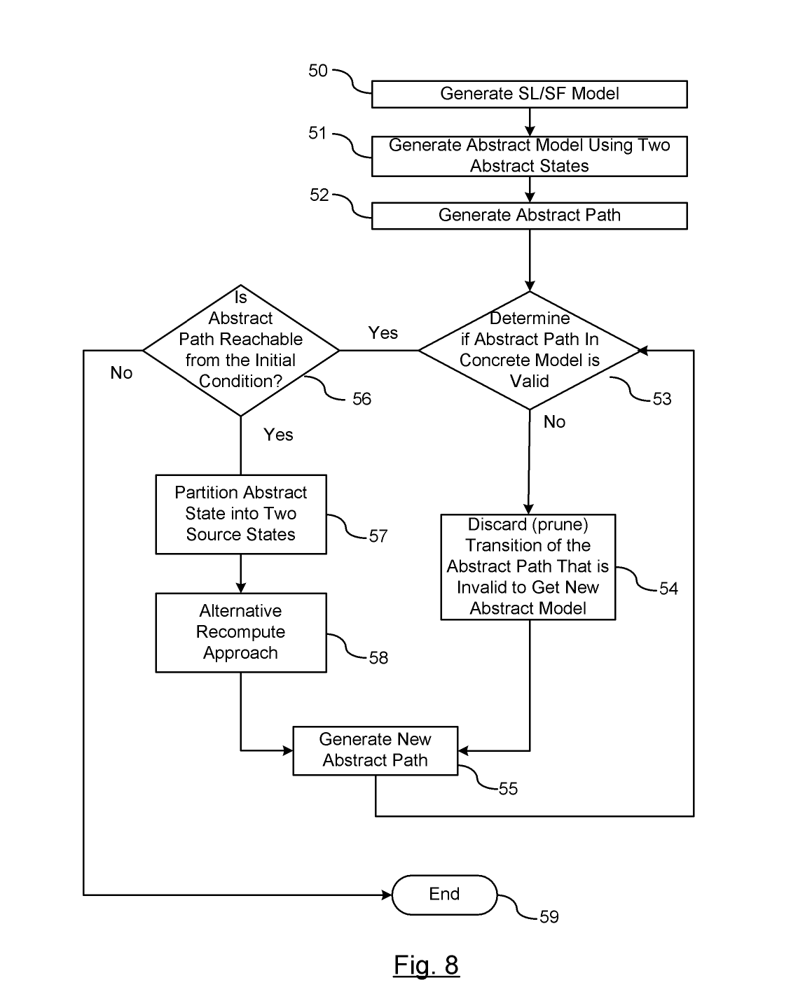

FIG. 8 illustrates a flowchart for determining a reachability of transition system models utilizing an enhanced partition refinement approach.

In step 50, a SL/SF concrete model is generated for a respective system or subsystem of a vehicle.

In step 51, an initial partition is selected for the abstract automata.

In step 52, an abstract path is determined in the abstract automata. The abstract path is a sequence of steps from a source abstract state to a target abstract state via a respective transition. This is referred to as a findpath technique.

In step 53, a validity check is performed on the abstract path in the concrete model. If the abstract path is determined to be invalid, then the routine proceeds to step 54. If the abstract path is determined to be valid, then the routine proceeds to step 56 to determine if the abstract path is infeasible from the initial condition.

In step 54, if transition between the respective states was found to be invalid, then the transition between the respective states in the abstract model is removed (i.e., pruned) and discarded. The routine then proceeds to step 55.

In step 55, a new abstract path is generated. The routine proceeds to step 53, to check the validity of the new abstract path.

In step 56, in response to the determination that the abstract path is valid, a determination is made as to whether the abstract path is feasible from the initial condition of the concrete model. If the determination is made that the abstract path is feasible, then the routine proceeds to 59 where the routine ends as a result of a valid and feasible solution. The result is output to a user that identifies whether the recomputed abstract path is a valid result for testing the concrete model in a vehicle system. If the determination that the abstract condition is infeasible, then the routine proceeds to step 57.

In step 57, the source state is partitioned into two additional state abstractions. The routine proceeds to step 58.

In step 58, an alternative recompute is performed. In a basic recomputed approach, after an abstract state (e.g., S) is partitioned into two states (e.g., S1 and S2), when a next abstract model is to be computed, the partitioned states are explicitly checked to determine if each state transitions into and out of S in the current abstract model and whether the transition will be feasible into and out of S1 and S2 in the next abstract model. Only those that are feasible are retained. This is expensive and time consuming since each check requires a call to a solver to perform this check. In the alternative recompute approach, all transitions are retained except for those that will definitely be infeasible without having to check explicitly with a solver. This is performed based on two facts. First, the use of an initial two state abstract model, and secondly, the SL/SF Simulink/Stateflow® concrete models are deterministic and transitions do not “overlap”. The extra transitions that get added due to the alternative recomputation are ones that will eventually get pruned away. This pruning occurs only if the extra transitions are ever encountered in the abstract paths that are generated. Thereafter, the routine proceeds to step 55 to generate a next abstract path.

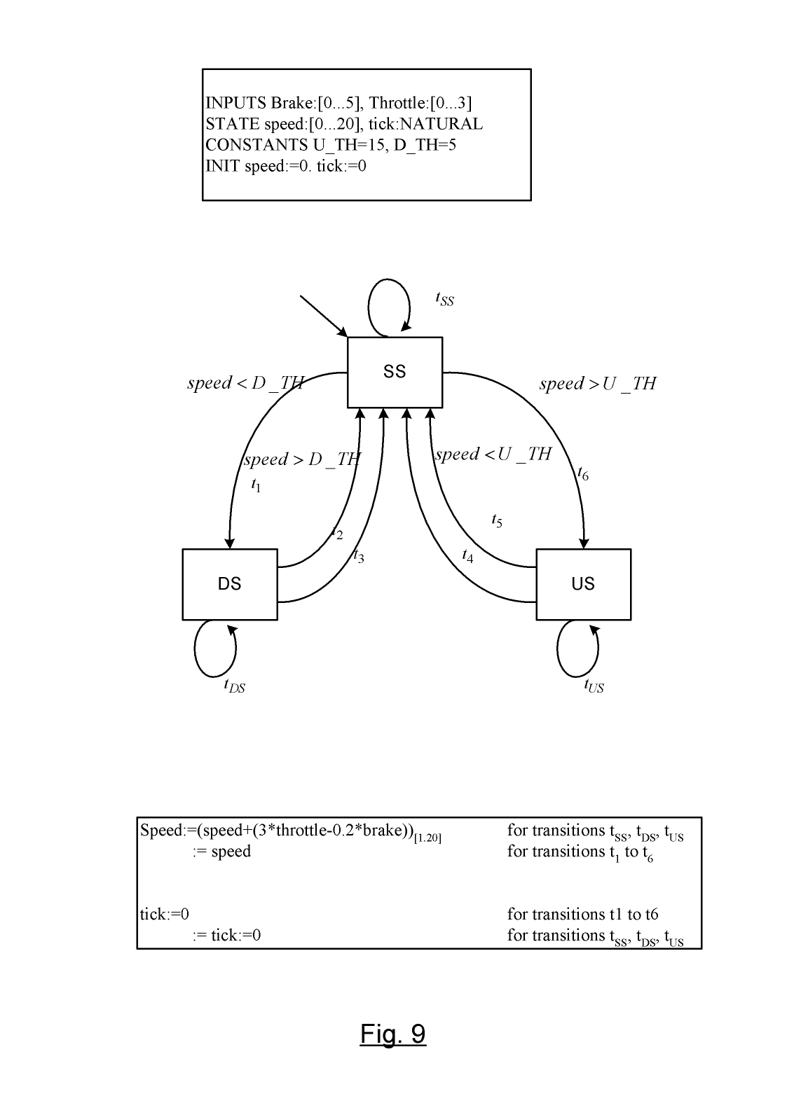

FIG. 9 illustrates a concrete SL/SF model as a transition system. In the concrete model, the system is modeled using properties of the actual system (e.g., speed properties, throttle properties, braking properties). The system models transitions between operation properties.

In the abstraction stage, the concrete model is replaced with a set of abstract states and those transitions (e.g., connections) with the states of the concrete model. The concept is to define the abstract model in terms of partitions of the state space of the concrete model.

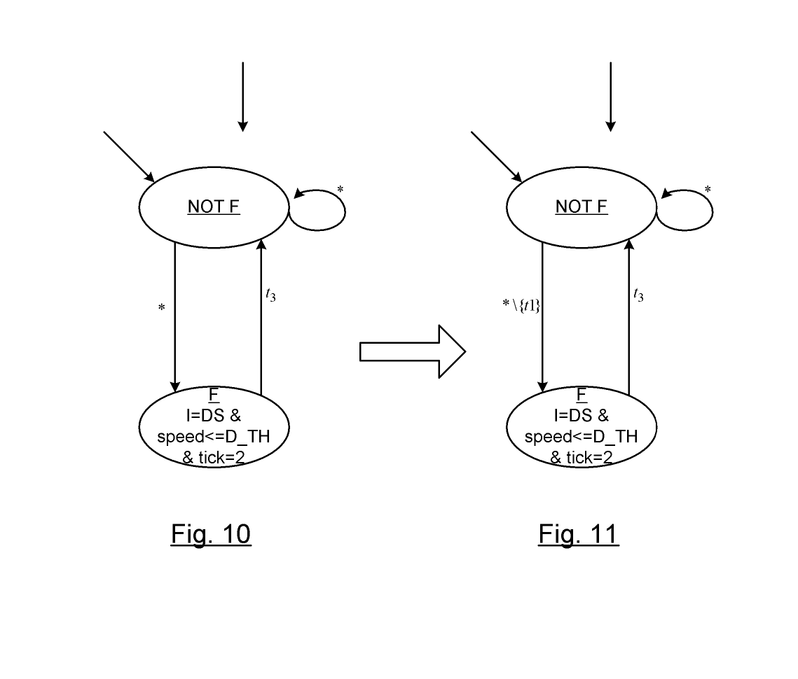

A respective transition is selected from the concrete model (e.g., t3). The abstract model is represented in FIG. 10. The objective is to generate a test to cover t3 for determining whether an abstract path is valid between the respective states in the concrete model. A first abstract path is generated utilizing transitions [symbol] t1,t3 [symbol] between the two initial abstraction states. A determination is made as to whether the abstract path is valid in the concrete model using the defined transition sequence. If the determination is that a failure occurred, then the invalid abstract path is refined. In this instance, t1 is invalid so the transition t1 is pruned as shown in FIG. 11.

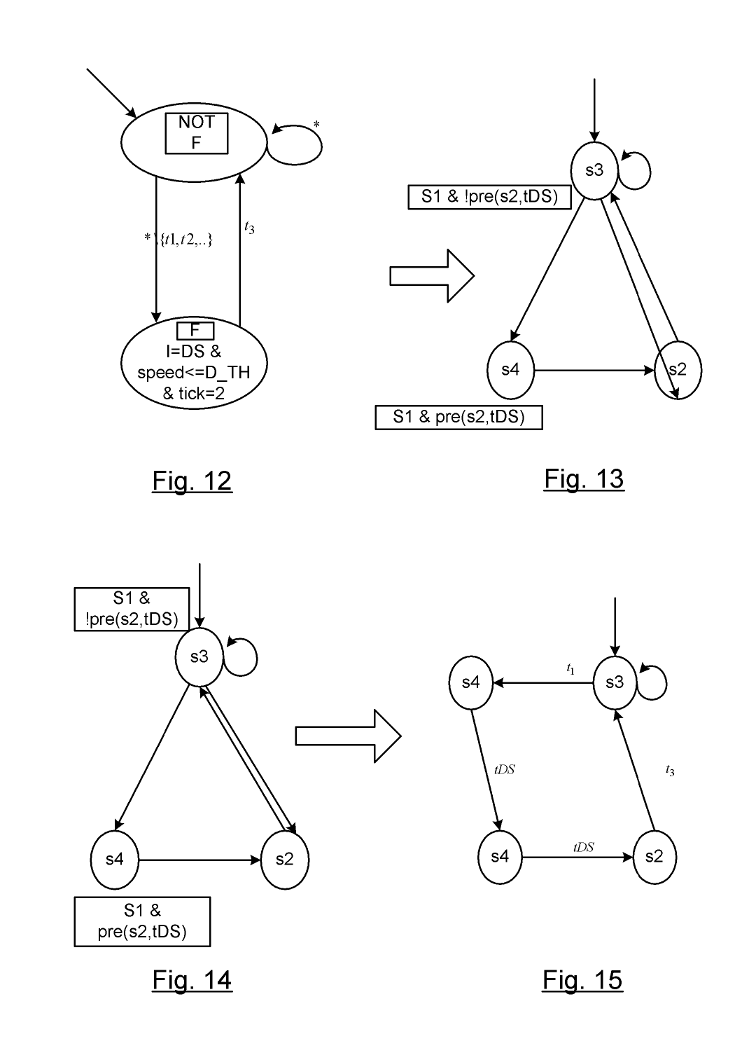

In FIG. 12, a next abstract path is generated using [symbol] tDS,t3 [symbol] . The test sequence is [symbol] s1, tDS, s2, t3 [symbol] . A determination is made whether the recently generated abstract path is valid in the concrete model. In the concrete model, the test sequence is found to be valid but infeasible. As a result, the abstract path is refined by partitioning as opposed to pruning. As discussed earlier, those transitions will eventually fall out in the pruning stages.

In FIG. 13, the state space S1 is partitioned to S3 and S4 and a lazy recomputed is performed. Additional iterations are performed on the state spaces/transitions in FIG. 14 until a valid and feasible transition path is obtained.

FIG. 15 illustrates a generated test sequence that is valid in the concrete model for t3. The resulting test sequence is [symbol] s5, t1, s6, tDS, s4, tDS, s2, t3 [symbol] .

While certain embodiments of the present invention have been described in detail, those familiar with the art to which this invention relates will recognize various alternative designs and embodiments for practicing the invention as defined by the following claims.

What is claimed is:

1. A method for verifying reachability of a transition between states with respect to design and simulation modeling, the method comprising the steps of:
generating a concrete simulation model by a processor as a transition system;
generating an abstract model by the processor having an abstract path that is a sequence of transition steps between a source state and a target state, the source state being an inverse of the target state;
checking a validity of the abstract path by the processor utilizing the concrete simulation model;
outputting a result to a user by an output device that identifies whether the abstract path is invalid in the concrete model; if invalid then;
discarding the abstract path;
generating a new abstract path by an output device;
re-checking a validity of each new abstract path by the processor;
if abstract path is valid in the concrete model, then determining whether the abstract path is reachable from an initial condition;
if reachable from the initial condition, then outputting the result to the user identifying the reachable transition between the source state and the target state;
otherwise, partitioning the source state into two additional state abstractions by the processor;
recomputing a refined abstract model by the processor retaining all transition paths except transitions that are determinative as invalid, the refined abstract model including a sequence of non-discarded transition steps;
rechecking validity of an abstract path associated with the refined abstract model using the concrete model; and
outputting a result to the user by the output device that identifies whether the recomputed abstract path is a valid result for testing the concrete model in a vehicle system.

2. The method of claim 1 wherein the source state is initially partitioned as a two state abstraction.

3. The method of claim 2 wherein initially partitioning the source state is based on a pre-image of a respective transition partitioned two state abstraction.

4. The method of claim 3 wherein the each of the abstract states partitioned after the source state has a valid outgoing transition step.

5. The method of claim 1 wherein the step of retaining all transition paths except transitions that are determinative as unreachable is performed without using a solver.

6. The method of claim 1 wherein a set of abstract states in an abstract model is a partition of concrete state in the concrete simulation model.

7. The method of claim 1 wherein the concrete model and transition abstract paths are tested in a vehicle wiring harness for determining validity of input and output control responses.

8. The method of claim 1 wherein the concrete model and transition paths are implemented in a vehicle.

9. The method of claim 1 wherein a processor is used for determining whether each transition out of the abstract state in the current abstract model will be reachable in and out of the partitioned states of the refined abstract model.

10. The method of claim 1 wherein a processor is used for determining whether a transition out of the abstract state in the current abstract model is valid in the concrete model.

11. The method of claim 1 wherein recomputing a refined abstract model further includes discarding transition abstract paths that are determinative as unreachable.
